(19) United States
(12) Patent Application Publication
(10) Pub. No.: US 2007/0017300 A1
(43) Pub. Date: Jan. 25, 2007

(54) Wear tester

(75) Inventors: John A. Bushey, Eden Prairie, MN (US); Jason A. Christopherson, Eden Prairie, MN (US); Steven R. Haeg, Minnetonka, MN (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: MTS Systems Corporation, Eden Prairie, MN (US)

(21) Appl. No.: 11/490,487

(22) Filed: Jul. 20, 2006

Related U.S. Application Data
(60) Provisional application No. 60/701,579, filed on Jul. 22, 2005.

(51) Int. Cl. G01N 3/02

(52) U.S. Cl. 73/856

(57) ABSTRACT

A test assembly structure having a first specimen support, a displacement mechanism joined to the first specimen support and a second specimen support. A loading assembly is joined to the second specimen support and configured so as to engage a specimen held by the second specimen support with a specimen held by the first specimen support. A self-reacting structure is joined to the loading assembly having a flexure substantially rigid in the direction of loading of the loading assembly and substantially compliant in the direction of displacement of the displacement mechanism. A second flexure can be configured to support the second specimen support and/or loading assembly on a base. The second flexure is substantially compliant in the direction of loading of the loading assembly and substantially rigid in the direction of displacement of the displacement mechanism.

### CROSS-REFERENCE TO RELATED APPLICATION

The present application is based on and claims the benefit of U.S. provisional patent application Ser. No. 60/701,579, filed Jul. 22, 2005, the content of which is hereby incorporated by reference in its entirety.

### BACKGROUND OF THE INVENTION

The discussion below is merely provided for general background information and is not intended to be used as an aid in determining the scope of the claimed subject matter.

Wear and fretting fatigue are phenomenon often prompted or caused by high frequency, low amplitude friction motion, which is typical in clamped joints and closely fitted components. Fretting fatigue is defined as the debit in fatigue for example due to early fatigue cracking initiation resulting from near surface stress risers developed from surface rubbing.

For instance, in one wear/fretting application, turbine blades are attached to a rotating shaft. The blades experience centrifugal forces as they rotate as well as other forces from gases passing by the blades. The attachment of the blades to the shaft are dynamically loaded connections, therefore, wear is present. It is desirable to characterize such wear in this application as well as many others.

### SUMMARY OF THE INVENTION

This Summary and the Abstract are provided to introduce some concepts in a simplified form that are further described below in the Detailed Description. The Summary and Abstract are not intended to identify key features or essential features of the claimed subject matter, nor is it intended to be used as an aid in determining the scope of the claimed subject matter. In addition, the description herein provided and the claimed subject matter should not be interpreted as being directed to addressing any of the short-comings discussed in the Background.

A first aspect of the invention is a test assembly structure having a first specimen support, a displacement mechanism joined to the first specimen support and a second specimen support. A loading assembly is joined to the second specimen support and configured so as to engage a specimen held by the second specimen support with a specimen held by the first specimen support. A self-reacting structure is joined to the loading assembly having a flexure substantially rigid in the direction of loading of the loading assembly and substantially compliant in the direction of displacement of the displacement mechanism.

A second aspect of the invention is a test assembly structure having a first specimen support, a displacement mechanism joined to the first specimen support and a second specimen support. A loading assembly is joined to the second specimen support and configured so as to engage a specimen held by the second specimen support with a specimen held by the first specimen support. A self-reacting structure is operably coupled to the loading assembly and the first specimen support and configured to react forces therebetween; A flexure is configured to support the second specimen support and/or loading assembly on a base, the flexure being substantially compliant in the direction of loading of the loading assembly and substantially rigid in the direction of displacement of the displacement mechanism.

### BRIEF DESCRIPTION OF THE FIGURES

FIG. 1 is a schematic diagram of a first embodiment of a wear test system.

FIG. 2 is a perspective view of a portion of the wear test system.

FIG. 3 is a schematic diagram of a second embodiment of a wear test system.

FIG. 4 is a perspective view of a third embodiment of a wear test system.

FIG. 5 is an elevational view of the wear test system of FIG. 4.

FIG. 6 is a top plan view of the wear test system of FIG. 4 taken along lines 6-6 of FIG. 5.

### DETAILED DESCRIPTION OF ILLUSTRATIVE EMBODIMENTS

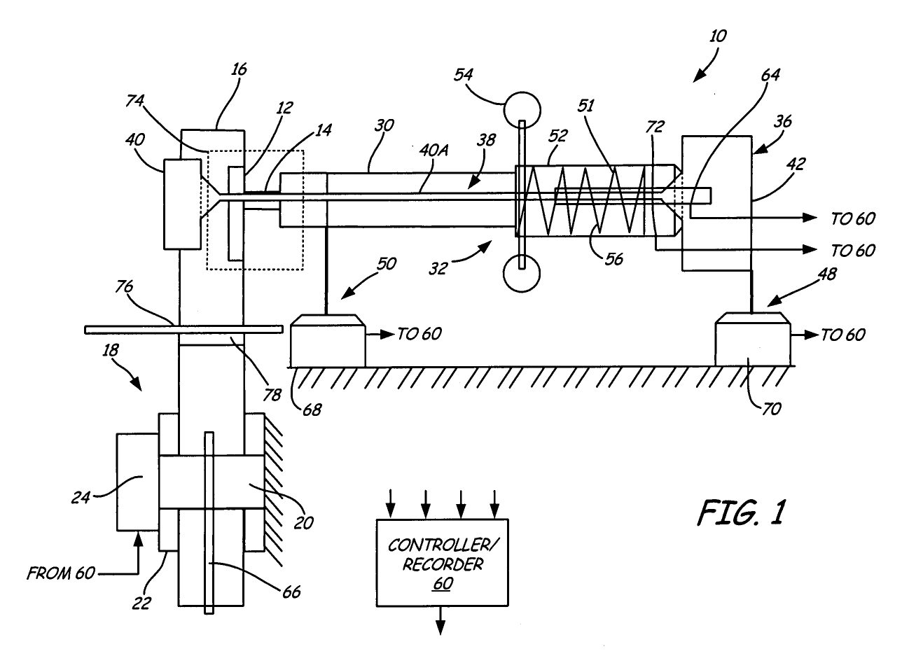

A wear tester system structure 10 is illustrated in FIG. 1 and is used to simulate, cause and/or characterize wear occurring between two specimens 12, 14. Specimen 12 is mounted to an axial specimen holder 16 that in turn is joined to a displacement assembly 18, herein exemplified as an actuator assembly. Actuator assembly 18 includes a piston 20 moveable in a cylinder 22 under the control of a servo valve 24. As appreciated by those skilled in the art, other forms of displacement assemblies such as other forms of actuator assemblies (e.g. electric, pneumatic, hydraulic, etc.) can be used.

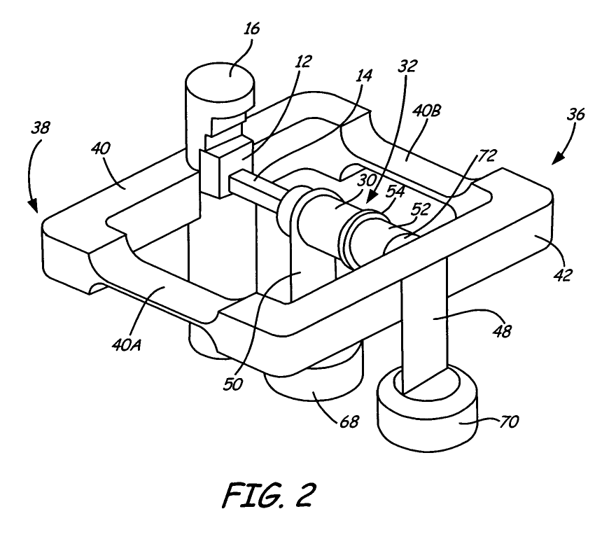

Specimen 14 likewise is mounted to a specimen holder 30 that in turn is joined to a loading assembly 32. Typically, specimen 14, specimen holder 30 and loading assembly 32 are oriented in so as to apply a force that is normal to axial displacement of specimen 12, although other orientations can be used. Referring also to FIG. 2, loading assembly 32 is mounted to member 36 so as to provide a self-reacting structure. Member 36 includes a flexure assembly 38 that is substantially rigid for loads supplied by the loading assembly 32, while compliant for displacements initiated by displacement mechanism 18. As illustrated, flexure assembly 38 includes one, but typically, two relatively thin flexures 40A and 40B, wherein rigid supports 40 and 42 are coupled at opposite ends of the flexure (s) 40A, 40B. Specimen holder 16 is coupled to support 40, while loading assembly 32 is coupled to support 42 so as to react forces therebetween. In addition, self-reacting structure 36/loading assembly 32 is/are coupled to a base 46 through a flexure assembly (herein exemplified as a flexure or flexible blade) 48 that is substantially rigid for forces in the axial direction of the displacement mechanism 18 and substantially compliant in the loading direction of loading assembly 32. Similarly, it is typically desirable to support the loading assembly 32 and/or specimen holder 30 with a flexure assembly 50 that is also substantially rigid for forces in the direction of displacement mechanism 18 and substantially compliant for forces in the direction applied by loading assembly 32. A flexible blade type flexure is an example of a suitable type flexure for these flexure assemblies although other forms can be used as appreciated by those skilled in the art.

In the embodiment illustrated by way of example, the loading assembly 32 can include a spring assembly 51 (compression and/or tension) configured in such a manner so as to load specimen 14 against specimen 12. In the embodiment illustrated, the spring assembly 51 includes a compression spring that urges the specimen holder 30 away from support 42. If desired, the loading can be adjustable herein exemplified by a hand crank 54 that is selectively fixable relative to the specimen holder 30 and/or housing 52 in order to compress spring 56. It should be understood that various types of loading assemblies 32 can be used such as but not limited to hydraulic, pneumatic and/or electric actuators. If desired, these actuators can be actively controlled so as to provide a selected load between specimens 12 and 14.

A controller/recorder 60 (exemplified herein as a single unit although a separate controller and recorder can be used) receives displacement signals from displacement sensor 64 (measures wear or displacement of specimen 14), and a displacement sensor 66 (measures displacement of specimen 12), and load signals from load cell 68 (axial load), load cell 70 (axial load), and load cell 72 (normal load). Herein displacement sensors 64 and 66 are exemplified as LVDT (Linear Variable Displacement Transducer); however, many different forms of displacement sensors can be used such as but not limited to those operable using electric (e.g. resistive, capacitive, etc.) and/or optical elements. Likewise, load cells 68, 70 and 72 herein represent suitable force sensors to measure loads. As appreciated by those skilled in the art, other load or force sensing devices can be used.

Using any or all of these signals and/or a control algorithm, the control/recorder 60 will control displacement of the specimen holder 16 and specimen 12, or loading of specimen 14 upon specimen 12, according to a desired test algorithm. Typically such a test is to provide wear information between specimens 12 and 14.

If desired, a furnace 74 schematically illustrated by dashed lines is provided to induce heat upon specimens 12 and 14. A heat sink 76 and an insulation material 78 would commonly be provided so as to isolate displacement mechanism 18 from the heat present in the specimen holder 16.

Although illustrated where a single specimen pair 12, 14 are present, it should be understood that a second pair of specimens could be provided on the opposite side of axial specimen holder 16, if desired.

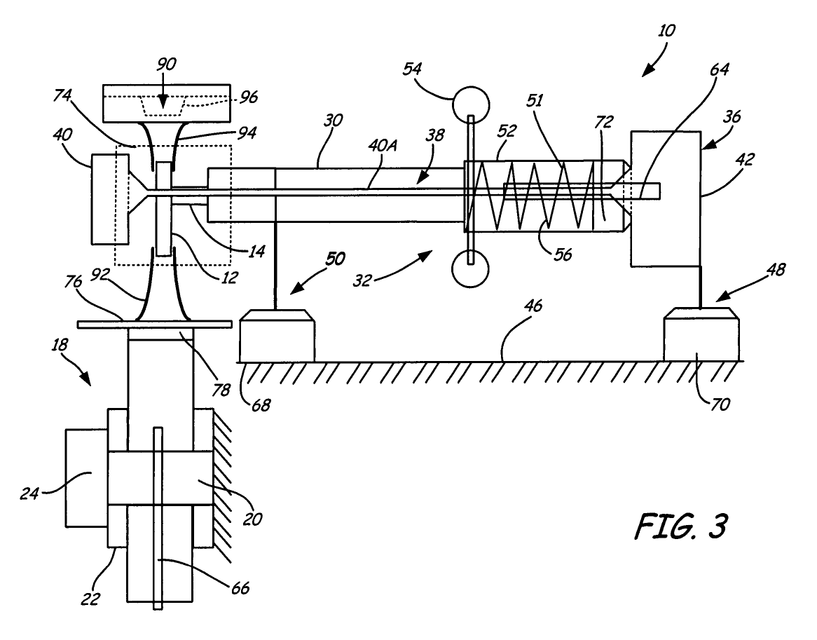

Referring to FIG. 3, a variant of wear system 10 is illustrated and can be used to provide fretting information. The same reference numbers have been used to identify similar components described and illustrated in FIG. 1. However, in this embodiment, specimen 12 is supported by an active or passive restraint mechanism 90. The restraint mechanism 90 allows tensile or compressive loads to be applied to specimen 12. Typically, a grip 92, which is well known in the material testing devices, is coupled to displacement mechanism 18 and supports the first end of specimen 12. A second grip 94 is coupled to restraint mechanism 90 and supports a second end of specimen 12. If restraint mechanism 90 is passive, restraint mechanism 90 can comprise a crosshead or other similar support that is held substantially fixed with respect to base 46. However, if restraint mechanism is active an actuator 96 (e.g., electric, hydraulic, pneumatic) is provided so as to allow tensile and compressive load of specimen 12 as well as slip amplitude control.

In conclusion, many variables have a significant effect on surface wear rates and fretting fatigue life. These include material type and finish, material compatibility, friction, normal loading, environmental conditions, temperature, stress state, geometric detail, and surface condition. The typical research will hold many of these variables constant, while adjusting the parameters of interest to obtain fatigue life data. Typically, both axial and normal load are two parameters that are closely controlled. In some cases, servocontrol may be used on the axial axis only, in other cases, both normal and axial load may be servocontrolled. Slip amplitude is another parameter of great interest that is often measured and/ or controlled. In the case of wear simulation, the test system simulates both the axial (wear) motion and the contact pressure loading. In the case of fretting fatigue simulation, the test system simulates the axial (fatigue) loading and the contact pressure loading. In some cases simultaneous control of the slip amplitude may be added to the system.

Without limitation some unique aspects taken alone or in combination include: the ability to provide a high frequency displacement input for wear testing using displacement mechanism 18; the ability to provide a high frequency load input for fretting fatigue testing using loading assembly 18/90; the ability to provide independent slip amplitude control for fretting fatigue testing if required; the ability to apply the wear load through a flexure assembly 38 that enables the wear force to be applied simultaneously to the high frequency input; the ability to apply and measure the wear load through a loading assembly such as a spring assembly 51, or through an actuator in closed loop load control, using a load transducer 72; the ability to measure wear displacement via incorporated position transducer 64; and the ability to measure the friction force using a unique flexure assembly 48/50 including load transducers 68/70, where the load transducers measure a force of the load assembly 32 and/or second specimen support 30 in the direction of displacement of the first specimen support 16.

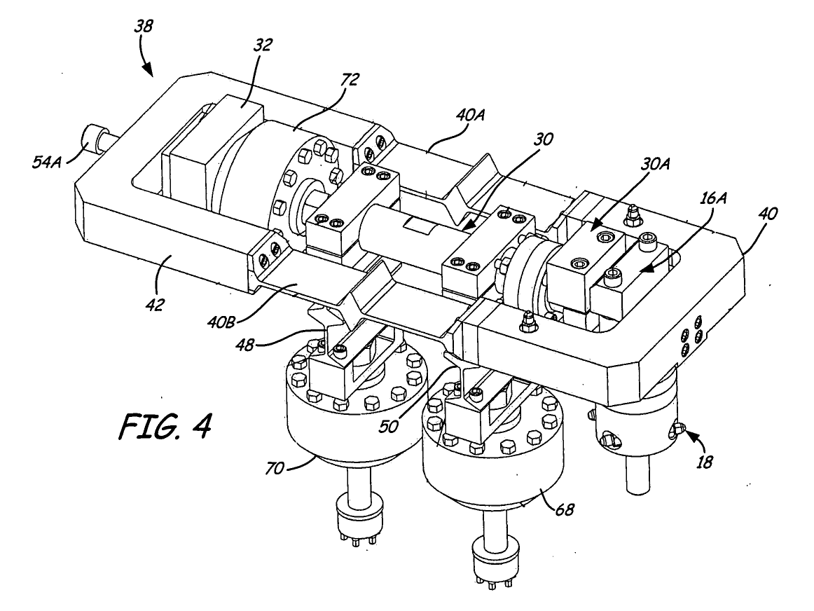

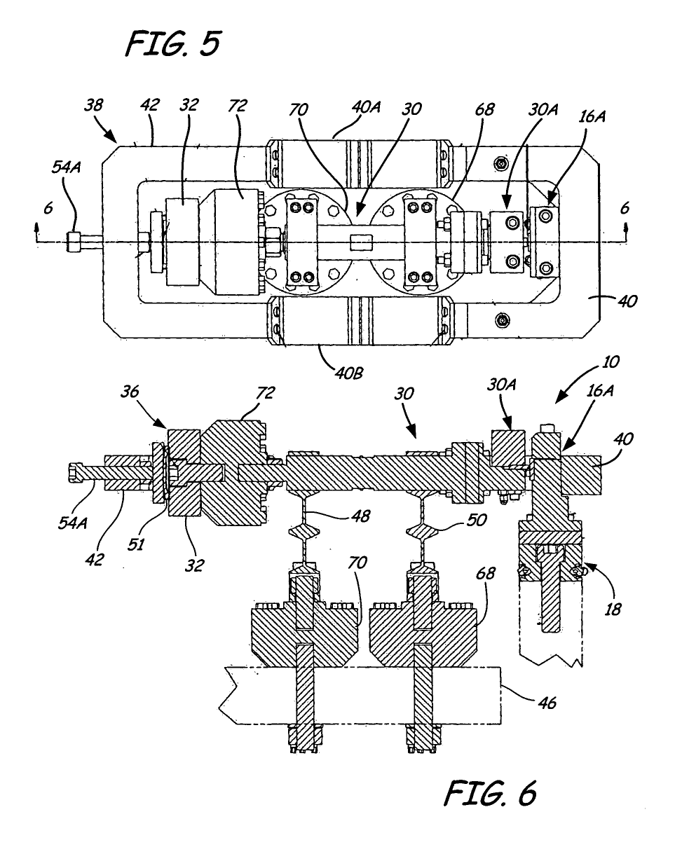

FIGS. 4-6 illustrate a third embodiment of a wear test system substantially similar to the previous embodiments wherein like components or elements are identified with the same reference numbers. Notable differences include a belleville washer used as spring assembly 51 where a bolt 54A is used to selectively compress the belleville washer. In addition, mentioned clamping blocks 16A and 30A are used to hold each test specimen on the holders 16, 30, respectively.

Although the subject matter has been described in language specific to structural features and/or methodological acts, it is to be understood that the subject matter defined in the appended claims is not limited to the specific features or acts described above as has been held by the courts. Rather, the specific features and acts described above are disclosed as example forms of implementing the claims.

What is claimed is:

1. A test assembly structure comprising:
a first specimen support;
a displacement mechanism joined to the first specimen support;
a second specimen support;
a loading assembly joined to the second specimen support and configured so as to engage a specimen held by the second specimen support with a specimen held by the first specimen support;
a self-reacting structure joined to the loading assembly having a flexure substantially rigid in the direction of loading of the loading assembly and substantially compliant in the direction of displacement of the displacement mechanism.

2. The test assembly structure of claim 1 and further comprising a second flexure supporting the loading assembly on a base, the second flexure being substantially compliant in the direction of loading of the loading assembly and substantially rigid in the direction of displacement of the displacement mechanism.

3. The test assembly structure of claim 2 wherein the second flexure comprises a flexible blade.

4. The test assembly structure of claim 2 and further comprising a third flexure supporting the second specimen support on a base, the third flexure being substantially compliant in the direction of loading of the loading assembly and substantially rigid in the direction of displacement of the displacement mechanism.

5. The test assembly structure of claim 4 wherein the second flexure comprises a flexible blade.

6. The test assembly structure of claim 1 and further comprising a second flexure supporting the second specimen support on a base, the second flexure being substantially compliant in the direction of loading of the loading assembly and substantially rigid in the direction of displacement of the displacement mechanism.

7. The test assembly structure of claim 6 wherein the second flexure comprises a flexible blade.

8. The test assembly structure of claim 4 wherein the first flexure comprises a flexible blade.

9. The test assembly structure of claim 1 wherein the self-reacting structure includes a second flexure on a side of the loading assembly opposite the first-mentioned flexure.

10. The test assembly structure of claim 9 and further comprising a first rigid member joined to each of the flexures and a second rigid member joined to each of the flexures, wherein the first rigid member is coupled to the first specimen support and the second rigid member is coupled to the and the loading assembly so as to react forces therebetween.

11. The test assembly of claim 1 a force sensor configured to measure force of the load assembly and/or second specimen support in the direction of displacement of the first specimen support.

12. The test assembly of claim 1 and further comprising:
a second flexure supporting the loading assembly on a base, the second flexure being substantially compliant in the direction of loading of the loading assembly and substantially rigid in the direction of displacement of the displacement mechanism;
third flexure supporting the second specimen support on a base, the third flexure being substantially compliant in the direction of loading of the loading assembly and substantially rigid in the direction of displacement of the displacement mechanism;
a first force sensor coupled to the second flexure to measure a force of the loading assembly in a direction of displacement of the first specimen support; and
a second force sensor coupled to the second flexure to measure a force of the loading assembly in a direction of displacement of the first specimen support.

13. The test assembly structure of claim 1 and further comprising an active restraint mechanism coupleable to the first specimen support.

14. The test assembly structure of claim 1 and further comprising a passive restraint mechanism coupleable to the first specimen support.

15. A test assembly structure comprising:
a first specimen support;
a displacement mechanism joined to the first specimen support;
a second specimen support;
a loading assembly joined to the second specimen support and configured so as to engage a specimen held by the second specimen support with a specimen held by the first specimen support;
a self-reacting structure operably coupled to the loading assembly and the first specimen support and configured to react forces therebetween;
a flexure configured to support the second specimen support and/or loading assembly on a base, the flexure being substantially compliant in the direction of loading of the loading assembly and substantially rigid in the direction of displacement of the displacement mechanism.

16. The test system of claim 15 and further comprising a force sensor configured to measure a force of the second specimen support and/or loading assembly in a direction of displacement of the displacement mechanism.

17. The test system of claim 15 wherein the flexure comprises a first flexure coupled to the loading assembly and a second flexure coupled to the second specimen support.

18. The test system of claim 17 and further comprising:
a first force sensor configured to measure a force of the second specimen support in a direction of displacement of the displacement mechanism; and
a second force sensor configured to measure a force of the loading assembly in a direction of displacement of the displacement mechanism.

19. A test assembly structure comprising:
a first specimen support;
a displacement mechanism joined to the first specimen support;
a second specimen support;
loading means for loading a specimen held by the second specimen support with a specimen held by the first specimen support;
means to react forces between the loading means and the first specimen support, said means including at least one flexure substantially rigid in the direction of loading of the loading assembly and substantially compliant in the direction of displacement of the displacement mechanism.
